(19) United States
(12) Patent Application Publication
(10) Pub. No.: US 2026/0103922 A1
(43) Pub. Date: Apr. 16, 2026

(54) DOOR HANDLE DEVICE

(71) Applicant: AISIN CORPORATION, Kariya (JP)

(72) Inventors: Kazuya KATO, Kariya-shi (JP); Shota YAMADA, Kariya-shi (JP)

(73) Assignee: AISIN CORPORATION, Kariya (JP)

(21) Appl. No.: 19/282,382

(22) Filed: Jul. 28, 2025

(30) Foreign Application Priority Data
Oct. 16, 2024 (JP) 2024-180557

(51) Int. Cl. E05B 85/10; E05B 79/22; E05B 85/16

(52) U.S. Cl. CPC E05B 85/107; E05B 79/22; E05B 85/103; E05B 85/16

(57) ABSTRACT

A door handle device includes a mechanism unit causing a door handle to transition from a first state of being retracted, via a second state of protruding, to a third state of being further pulled out from the second state, a door latch device including a movable portion, and a rod or lever. The door latch device is switched between a door locking state and an unlocking state in response to a position change of the movable portion in an up-down direction. The rod or lever includes one end connected to the mechanism unit and an opposite end connected to the movable portion. The mechanism unit includes a latch drive mechanism that moves the opposite end of the rod or lever in the up-down direction, based on movement of the door handle from the second state to the third state.

### CROSS REFERENCE TO RELATED APPLICATIONS

This application is based on and claims priority under 35 U.S.C. § 119 to Japanese Patent Application 2024-180557, filed on Oct. 16, 2024, the entire content of which is incorporated herein by reference.

### TECHNICAL FIELD

This disclosure generally relates to a door handle device.

### BACKGROUND DISCUSSION

There is known a door handle device that uses a horizontally actuated pop-up type flush handle which is disclosed in CN219451814U, for example. According to this door handle device, a door handle transitions from a first state where the door handle is retracted along a surface of a door outer panel, via a second state where the door handle protrudes from the surface of the door outer panel, to a third state where the door handle is further pulled out from the second state, in response to one or both of actuation of an actuator and operation from a user.

However, in this kind of door handle device using the horizontally actuated pop-up type flush handle, a mechanism of the door handle is connected to a door latch via a cable, as in the above-described conventional technique. This is because a stroke direction of a release lever of the door latch device is perpendicular to a stroke direction of a bell crank that is included in the mechanism of the door handle and that operates the door latch. In the case of such a connection mechanism using the cable, there is a problem that a cost becomes higher than that in a connection mechanism using a rod or a lever.

A need thus exists for a door handle device, which is not susceptible to the drawback mentioned above.

### SUMMARY

One aspect provides a door handle device including a mechanism unit, a door latch device, and a rod or lever. The mechanism unit causes a state of a door handle provided on a side of a door outer panel to transition from a first state where the door handle is retracted along a surface of the door outer panel, via a second state where the door handle protrudes from the surface of the door outer panel, to a third state where the door handle is further pulled out toward a vehicle outer side from the second state. The door latch device includes a movable portion that is movable between an upper position and a lower position. The door latch device is switched between a door locking state and an unlocking state in response to a change in position of the movable portion in an up-down direction. The rod or lever includes one end connected to the mechanism unit and an opposite end connected to the movable portion of the door latch device. The mechanism unit includes a latch drive mechanism that moves the opposite end of the rod or lever in the up-down direction, based on movement of the door handle from the second state to the third state.

### BRIEF DESCRIPTION OF THE DRAWINGS

The foregoing and additional features and characteristics of this disclosure will become more apparent from the following detailed description considered with the reference to the accompanying drawings, wherein:

FIG. 1 illustrates one example of a vehicle equipped with a door handle device according to this example;

FIG. 2 illustrates an initial state (stored state) of a door outside handle;

FIG. 3A is an enlarged view of a part Q11 in FIG. 2;

FIG. 3B is an enlarged view of a part Q12 in FIG. 2;

FIG. 4 illustrates a popped-up state where the door outside handle protrudes from a surface of a door outer panel;

FIG. 5 illustrates an operation completed state where the door outside handle is pulled out from the popped-up state;

FIG. 6 is a perspective view illustrating a bell crank and its surrounding configuration; and

FIG. 7 is a sectional view taken along a rotational plane (XZ plane) of the bell crank.

### DETAILED DESCRIPTION

The following describes respective examples in detail with reference to the accompanying drawings. Dimensional ratios in the drawings are merely examples, and there is no limitation to these. In some cases, a shape or the like in the drawing is partially emphasized for convenience of the description. In some cases, in the drawing, for ease of viewing, the reference sign is assigned only to a part of a plurality of existing portions having the same attribute.

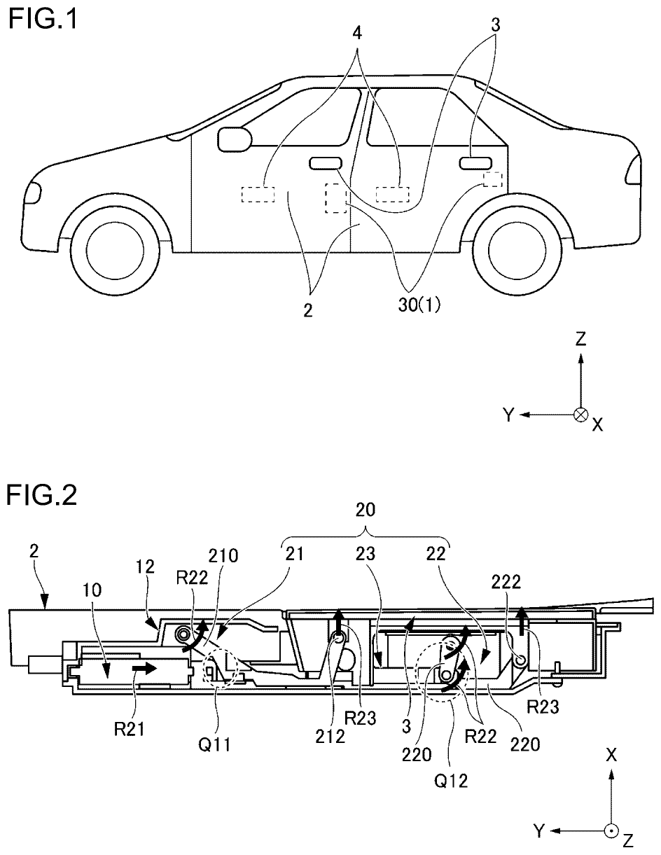

FIG. 1 illustrates one example of a vehicle equipped with a door handle device 1 according to this example.

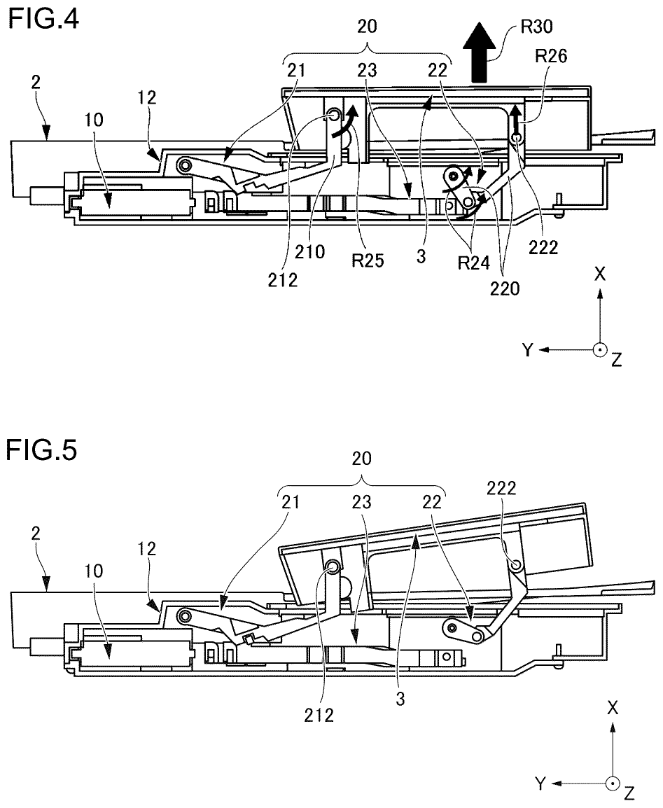

FIG. 1 (and FIG. 2, FIG. 4, and FIG. 5 described below) illustrates three orthogonal axes X, Y, and Z in a right-handed coordinate system. Here, the X direction corresponds to a vehicle width direction. The Y direction corresponds to a vehicle front-rear direction, and a positive side in the Y direction is a front side. The Z direction corresponds to a vertical direction. However, actually, one or each of the vehicle width direction, the vehicle front-rear direction, and the vertical direction (gravity direction) may be slightly inclined (e.g., by less than 20 degrees) from the corresponding one of the X direction, the Y direction, and the Z direction. In other words, the X direction, Y direction, and Z direction includes, as main direction components, the vehicle width direction, the vehicle front-rear direction, and the vertical direction (gravity direction), respectively.

The door handle device 1 is incorporated in a vehicle door. In other words, the door handle device 1 is provided mainly between a door outer panel 2 and a door inner panel (not illustrated) of the vehicle. The vehicle door in which the door handle device 1 is incorporated may be an arbitrary door, and may be any door except for a back door.

A door outside handle 3 is provided in the door outer panel 2. In an initial state (one example of a first state), the door outside handle 3 is retracted along a surface of the door outer panel 2 (i.e., is stored). For example, the door outside handle 3 is stored inside the door (on a negative side of the door outer panel 2 in the X direction) in such a way that a surface of the door outside handle 3 on a positive side in the X direction (on a vehicle outer side) is substantially continuous with the surface of the door outer panel 2. Movement of the door outside handle 3 is described below in detail with reference to FIG. 2 and subsequent figures.

The door handle device 1 includes a door latch device 30. The door latch device 30 is mechanically connected to the door outside handle 3 and a door inside handle 4. The door latch device 30 operates in response to a user input via the door outside handle 3 or the door inside handle 4, and thereby switches the door between a locked state and an unlocked state.

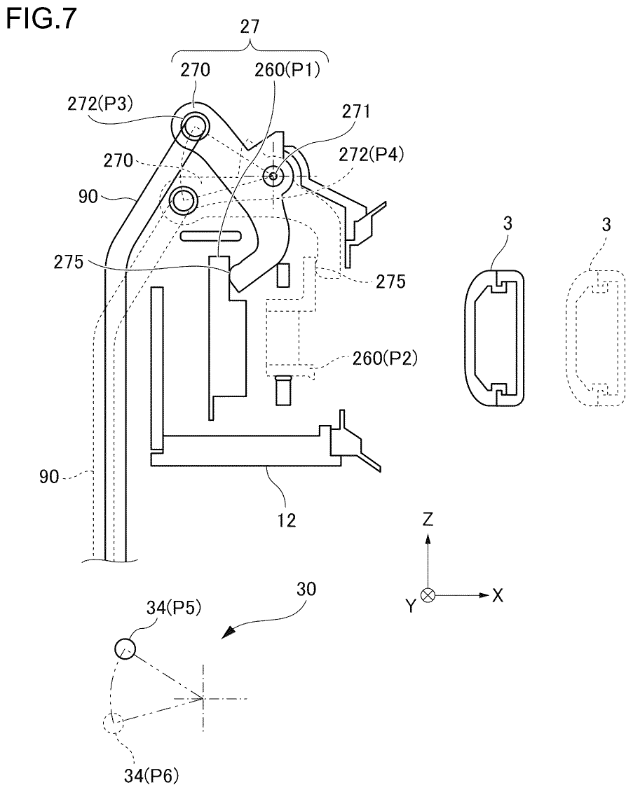

Details of the door latch device 30 may be arbitrary. In this example, the door latch device 30 includes a release lever (refer to FIG. 7) as one example. Stroking of the release lever in an up-down direction causes switching between a locking state where a latch engages with a striker (not illustrated) on a vehicle body side and an unlocking state where the latch disengages from the striker. In this manner, the locking state and the unlocking state are switched. Here, the up-down direction does not need to be strictly parallel to the vertical direction (gravity direction), and may be slightly inclined from the vertical direction (gravity direction). The door latch (not illustrated) is rotatable around a rotational axis extending in the Y direction, and rotates in conjunction with the vertical-direction stroking of a rod connection portion 34 (refer to FIG. 7) of the release lever of the door latch device 30.

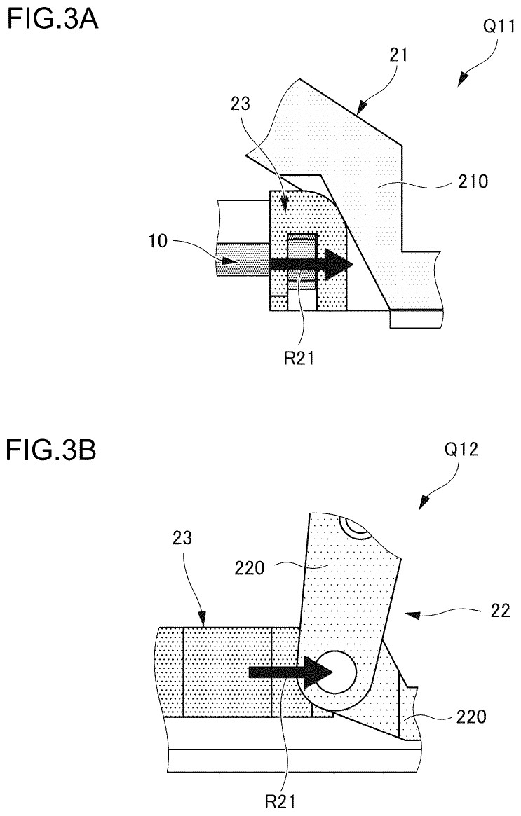

FIG. 2 to FIG. 5 are illustrations schematically depicting the door handle device 1 according to this example. FIG. 2 illustrates an initial state (stored state) of the door outside handle 3. FIG. 3A is an enlarged view of the part Q11 in FIG. 2. FIG. 3B is an enlarged view of the part Q12 in FIG. 2. FIG. 4 illustrates a popped-up state where the door outside handle 3 protrudes from the surface of the door outer panel 2. FIG. 5 illustrates an operation completed state where the door outside handle 3 is pulled out from the popped-up state. FIG. 2, FIG. 4, and FIG. 5 are views in the vehicle up-down direction, and transparently illustrate a main part of the door handle device 1.

The door handle device 1 further includes an actuator 10, a case portion 12, and a mechanism unit 20.

The actuator 10 operates based on a control signal from an unillustrated electronic control unit (ECU). The actuator 10 is mechanically connected to the mechanism unit 20, and generates power for operation of the mechanism unit 20. In this example, the actuator 10 generates the power for transition from the initial state (FIG. 2) to the popped-up state (refer to FIG. 4, one example of a second state).

The case portion 12 is fixed to the door outer panel 2. The case portion 12 supports the mechanism unit 20. For example, the case portion 12 fixes each rotation shaft (a rotation shaft 212 and the like) included in the mechanism unit 20 and parallel to the Z axis. The case portion 12 may support the actuator 10.

The mechanism unit 20 causes a state of the door outside handle 3 provided on a side of the door outer panel 2 to transition from the initial state (FIG. 2), via the popped-up state (FIG. 4), to the operation completed state (FIG. 5).

In this example, the mechanism unit 20 includes a plurality of link mechanisms 21 and 22, a slider 23, and the like. A plurality of the link mechanisms 21 and 22 are supported by the case portion 12 in such a way as to be rotatable as described below. The slider 23 is supported by the case portion 12 in a such a way as to be slidable (translationally movable) in the Y direction. Each of the link mechanisms 21 and 22 and the slider 23 (and the door outside handle 3 following this) moves basically in the XY plane.

Here, a schematic configuration of the mechanism unit 20 is outlined along with operation of the mechanism unit 20. The configuration of the mechanism unit 20 described here is merely one example. Details of the mechanism unit 20 are arbitrary as long as the mechanism unit 20 can implement the function of causing the transition from the initial state (FIG. 2) to the operation completed state (FIG. 5) via the popped-up state (FIG. 4).

FIG. 2 to FIG. 5 schematically indicate the movement of the mechanism unit 20 and the like by the arrows such as the arrow R20.

In the initial state, when an actuation condition is satisfied and the actuator 10 is actuated, the slider 23 thereby moves to a negative side in the Y direction (refer to the arrows R21 in FIG. 3A and FIG. 3B). The actuation condition is arbitrary. For example, the actuation condition may be satisfied when a rightful user touches, with his or her hand, a touch sensor that may be incorporated in the door outside handle 3. Whether the user is a rightful user may be determined based on a key identifier acquired via communication between an on-vehicle device (not illustrated) and an electronic key (an electronic key possessed by the user).

When the actuator 10 is actuated and the slider 23 thus moves to a negative side in the Y direction, the slider 23 thereby pushes out an arm 210 of the link mechanism 21 and an arm 220 of the link mechanism 22 to a negative side in the Y direction. Accordingly, the arm 210 of the link mechanism 21 and the arm 220 of the link mechanism 22 rotate (refer to the arrows R22). As a result, the door outside handle 3 pops up (refer to the arrow R23) in a such a way as to be pushed out to a vehicle outer side (a positive side in the X direction). At this time, both a vehicle-front-side portion and a vehicle-rear-side portion of the door outside handle 3 may be displaced (popped out) by substantially the same amount. In other words, the door outside handle 3 may pop up while being oriented substantially parallel to the Y direction.

In the popped-up state (FIG. 4), a user (a user about to get into the vehicle) can grip the door outside handle 3 and pull the door outside handle 3 out to a vehicle outer side (to a positive side in the X-direction). When the door outside handle 3 is pulled out to a vehicle outer side (to a positive side in the X-direction) (refer to the arrow R30), the arm 220 of the link mechanism 22 thereby rotates (refer to the arrow R24). Aa a result, the door outside handle 3 rotates around the rotation shaft 212 of the link mechanism 21 (refer to the arrow R25) while a rotation shaft 222 of the link mechanism 22 is displaced to a positive side in the X-direction (refer to the arrow R26), resulting in the operation completed state (refer to FIG. 5, one example of a third state).

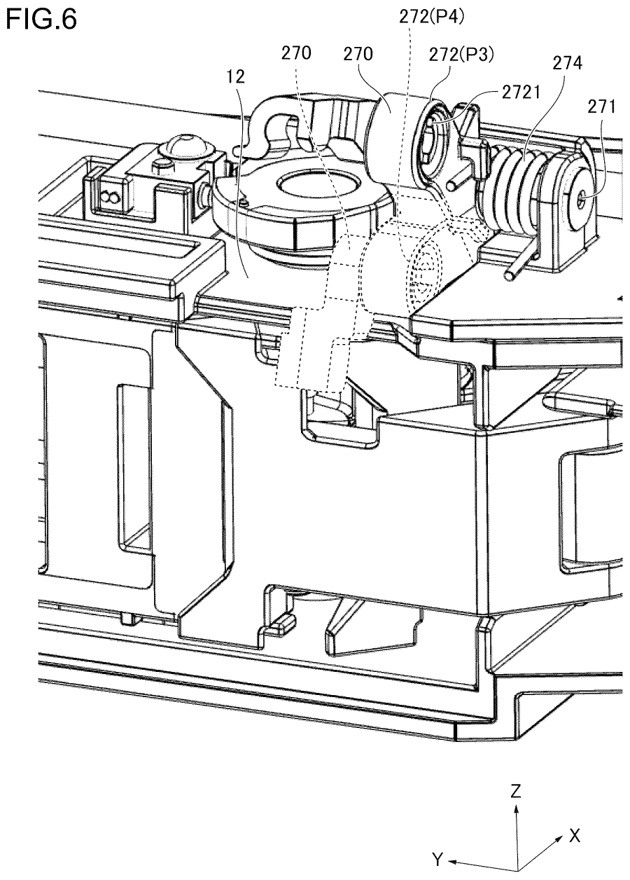

Next, the features of this example are described with reference to FIG. 6.

FIG. 6 is a perspective view illustrating a bell crank 270 and its surrounding configuration. FIG. 7 is a sectional view taken along a rotational plane (XZ plane) of the bell crank 270. Each of FIG. 6 and FIG. 7 illustrates the bell crank 270 in the popped-up state and in the operation completed state. In this regard, the bell crank 270 in the operation completed state is depicted by the broken lines for distinction. FIG. 6 omits an illustration of a rod 90 illustrated in FIG. 7. FIG. 7 schematically illustrates the rod connection portion 34 on a side of the door latch device 30.

In this example, the mechanism unit 20 includes a latch drive mechanism 27 that is connected to the door latch device 30 via the rod 90. The latch drive mechanism 27 mechanically drives the door latch device 30 via the rod 90, based on the movement of the door outside handle 3 from the popped-up state to the operation completed state. Specifically, the latch drive mechanism 27 causes the door latch device 30 to move from a door locking state to an unlocking state, based on the movement of the door outside handle 3 from the popped-up state to the operation completed state.

In this example, the latch drive mechanism 27 includes a bell crank drive portion 260 and the bell crank 270.

The bell crank drive portion 260 is a part that mechanically drives (rotates) the bell crank 270 in conjunction with the transition of the door outside handle 3 from the popped-up state to the operation completed state. In this example, when viewed in the Y direction, the bell crank drive portion 260 is displaced from a contact position P1 (one example of a first position) to a drive position P2 (one example of a second position) in conjunction with the transition of the door outside handle 3 from the popped-up state to the operation completed state. At the contact position P1, the bell crank drive portion 260 contacts against an end portion 275 of the bell crank 270 from a negative side in the X direction. The drive position P2 is on a positive side of the contact position P1 in the X direction. From the contact position P1 to the drive position P2, the bell crank drive portion 260 is kept in contact against the end portion 275 of the bell crank 270. Accordingly, a stroke of the bell crank drive portion 260 in the X direction from the contact position P1 to the drive position P2 causes the rotation (the rotation around a rotation shaft 271) of the bell crank 270.

The bell crank drive portion 260 may be a part that is formed integrally with the door outside handle 3, or may be a member that moves integrally with the door outside handle 3 by being coupled to the door outside handle 3.

The bell crank 270 is supported by the case portion 12 in such a way as to be rotatable around the rotation shaft 271 that is parallel to the Y direction. Thus, the bell crank 270 moves in the XZ plane. The bell crank 270 includes two end portions located on both sides and sandwiching the rotation shaft 271 between themselves. One of these two end portions contacts against the bell crank drive portion 260, and the other of these two end portions is connected to rod 90.

The bell crank 270 includes a rod connection portion 272 to which one end of the rod 90 is connected. The rod connection portion 272 may include an insertion hole 2721 (refer to FIG. 6) into which the rod 90 can be inserted in the Y direction. The bell crank 270 rotates in such a way that when the door outside handle 3 is in the popped-up state, the rod connection portion 272 is located at a position P3 (one example of a third position), and when the door outside handle 3 is in the operation completed state, the rod connection portion 272 is located at a position P4 (one example of a fourth position). The position P4 is located on a lower side (on a negative side in the Z direction) of the position P3. The bell crank 270 may be biased toward the position P3 by a spring 274 (refer to FIG. 6).

When the rod connection portion 272 of the bell crank 270 moves from the position P3 to the position P4, the other end of the rod 90 (and the rod connection portion 34 of the release lever of the door latch device 30 following the other end of the rod 90) thereby moves (strokes) from a position P5 to a position P6, as schematically illustrated in FIG. 7. Thus, a state of the door latch device 30 is switched from the locking state to the unlocking state. In the example illustrated in FIG. 7, the release lever including the rod connection portion 34 has a rotation axis parallel to the Y direction, and rotates in the XZ plane.

In this manner, according to this example, the movement (the movement in the XY plane) of the door outside handle 3 can be converted into the movement of the bell crank 270 (the movement in the XZ plane) that is perpendicular to this movement of the door outside handle 3. For this reason, connecting the rod 90 to the bell crank 270 enables the latch of the door latch device 30 to be moved via the rod 90. Thereby, the mechanism unit 20 and the door latch device 30 can be mechanically connected to each other via the connection mechanism using the relatively inexpensive rod 90, without a connection mechanism using a relatively expensive cable. According to this example, substantially merely adding the bell crank 270 enables the mechanism unit 20 and the door latch device 30 to be mechanically connected to each other via the rod 90. Thus, the cost reduction can be achieved with the simple configuration while the number of components is prevented from being significantly increased.

In this example, the mechanism unit 20 and the door latch device 30 are mechanically connected to each other via the rod 90. However, a lever may be used instead of the rod 90.

In the door latch device 30, a member that can reciprocate in the up-down direction may be used instead of the release lever. In this case, the rod connection portion 34 may move in the up-down direction in response to the movement of the member in the up-down direction.

Although each of the examples is described above in detail, there is no limitation to the specific example, and various modifications and changes can be made within the scope of the claims. All or a plurality of the constituents of the above-described examples may be combined with each other.

One aspect provides a door handle device including a mechanism unit, a door latch device, and a rod or lever. The mechanism unit causes a state of a door handle provided on a side of a door outer panel to transition from a first state where the door handle is retracted along a surface of the door outer panel, via a second state where the door handle protrudes from the surface of the door outer panel, to a third state where the door handle is further pulled out toward a vehicle outer side from the second state. The door latch device includes a movable portion that is movable between an upper position and a lower position. The door latch device is switched between a door locking state and an unlocking state in response to a change in position of the movable portion in an up-down direction. The rod or lever includes one end connected to the mechanism unit and an opposite end connected to the movable portion of the door latch device. The mechanism unit includes a latch drive mechanism that moves the opposite end of the rod or lever in the up-down direction, based on movement of the door handle from the second state to the third state.

According to one aspect of this disclosure, a connection mechanism using a rod or a lever can be achieved in a door handle device using a horizontally actuated pop-up type flush handle.

In the door handle device, the latch drive mechanism may include a bell crank rotating around a rotation shaft whose main direction component is a vehicle front-rear direction, and the rod or lever may include the one end connected to the bell crank.

In the door handle device, the latch drive mechanism may include a portion or member that is integrally formed with or coupled to the door handle, when viewed in an axial direction of the rotation shaft, accompanying movement of the door handle from the second state to the third state, the portion or member may be displaced from a first position to a second position that is on a vehicle outer side of the first position in a vehicle width direction, the bell crank may include a first end contacting against the portion or member and a second end connected to the rod or lever, and rotation of the bell crank accompanying displacement of the portion or member from the first position to the second position may cause the second end of the bell crank to move from a third position to a fourth position that is on a lower side of the third position.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A door handle device comprising:
a mechanism unit that causes a state of a door handle provided on a side of a door outer panel to transition from a first state where the door handle is retracted along a surface of the door outer panel, via a second state where the door handle protrudes from the surface of the door outer panel, to a third state where the door handle is further pulled out toward a vehicle outer side from the second state;
a door latch device including a movable portion that is movable between an upper position and a lower position, and being switched between a door locking state and an unlocking state in response to a change in position of the movable portion in an up-down direction; and
a rod or lever that includes one end connected to the mechanism unit and an opposite end connected to the movable portion of the door latch device, wherein
the mechanism unit includes a latch drive mechanism that moves the opposite end of the rod or lever in the up-down direction, based on movement of the door handle from the second state to the third state.

2. The door handle device according to claim 1, wherein
the latch drive mechanism includes a bell crank rotating around a rotation shaft whose main direction component is a vehicle front-rear direction, and
the rod or lever includes the one end connected to the bell crank.

3. The door handle device according to claim 2, wherein
the latch drive mechanism includes a portion or member that is integrally formed with or coupled to the door handle,
when viewed in an axial direction of the rotation shaft, accompanying movement of the door handle from the second state to the third state, the portion or member is displaced from a first position to a second position that is on a vehicle outer side of the first position in a vehicle width direction,
the bell crank includes a first end contacting against the portion or member and a second end connected to the rod or lever, and
rotation of the bell crank accompanying displacement of the portion or member from the first position to the second position causes the second end of the bell crank to move from a third position to a fourth position that is on a lower side of the third position.
